(19) United States
(12) Patent Application Publication
(10) Pub. No.: US 2008/0108014 A1
(43) Pub. Date: May 8, 2008

(54) DEVICE FOR HOLDING A MODEL

(75) Inventors: Stephan Holzner, Hohenschaftlarn (DE); Gerhard Weber, Purgen (DE)

Correspondence Address: DARBY & DARBY P.C., P.O. BOX 770, Church Street Station, New York, NY, 10008-0770, US

(73) Assignee: etkon Centrum fur dentale CAD/CAM-Technologie AG, Grafelfing (DE)

(21) Appl. No.: 11/936,192

(22) Filed: Nov. 7, 2007

(30) Foreign Application Priority Data
Nov. 7, 2006 (DE) 102006052420.9

(51) Int. Cl. A61C 3/00

(52) U.S. Cl. 433/163; 29/896.1

(57) ABSTRACT

The invention refers to a device for holding a model of a dental prosthesis part, such as an abutment, comprising a first portion in which the model of the dental prosthesis part can be modeled on and a second portion which allows a definite position identification of the holder, as well as a device for scanning objects, such as a jaw model and/or dental models and/or saw tooth model sections, comprising a holder in which an above-mentioned device with a definite position orientation can be held and scanned. The invention further refers to a method of generating a digital model of a dental prosthesis part, such as an abutment, comprising the steps of evaluating the scan data for detecting at least one part of the shape of the dental prosthesis part and evaluation of the scan data to detect at least the position of the holder, a data carrier with instructions to carry out such a method as well as a method of manufacturing a dental prosthesis part.

The invention refers to a device for holding a model of a dental prosthesis part, a device for scanning objects, a method of producing a digital model of a dental prosthesis part as well as an associated data carrier, and a method of manufacturing a dental prosthesis part.

Modeling dental prosthesis parts, such as an abutment, is known. An abutment is dental care part that is for instance screwed onto an implant. A crown or a bridge or the like can be set onto the abutment.

Usually, standard abutments are used which are adapted or associated to a respective implant.

It is the object of the present invention to provide means and methods by means of which an automated manufacture of individual abutments or other dental prosthesis parts is enabled. This object is solved by a holding device according to claim 1, a device for scanning objects according to claim 10, a method of producing a digital model of a dental prosthesis part according to claim 11, a method of manufacturing a dental prosthesis part according to claim 16 and a computer-readable medium as claimed in claim 17. Preferred embodiments are disclosed in the dependent claims.

The device for holding a model of a dental prosthesis part, such as an abutment, has two portions. The model of a dental prosthesis part can be modeled onto the first portion or a respective model can be set on. The second portion allows a clear position identification of the holding device. The second portion is preferably not covered by the model of the dental prosthesis part so that this second portion remains optically accessible.

Such a model of a dental prosthesis part can for instance be modeled out of wax, whereby a light, fast and individual and well known modeling mode can be used.

The holding device is preferably dimensioned such that it can comprise one model of a dental prosthesis part only, which can be associated to one single tooth, such as an abutment, which belongs to exactly one implant (instead of one tooth).

The position of the holding device can be detected by a second portion. If the position of the holding device is known, the position of the first portion is also known. Since the model is modeled or set onto the first portion, the inner shape of the dental prosthesis part can also be defined by detecting the outer shape of the model and by determining the position of the holding device and thus also the position of the first portion.

It is for instance advantageous if the first portion already corresponds to the desired inner shape of a dental prosthesis part or if a receptacle for a model piece is formed in the first portion, wherein this model piece shall correspond to the inner shape of the dental prosthesis part. In this manner it is possible for modeling of the dental prosthesis part to take into consideration the inner shape prevailing later in the real dental prosthesis part.

The second portion preferably comprises at least one, two, three or more planar surfaces. Such planar surfaces can advantageously be used for position identification of the holding device.

Furthermore, the second portion may comprise one, two, three or more shape markings. Shape markings are markings that are defined by the shape. Possible variants of a shape marking comprise groove, recess, elevation, sphere, hemisphere, a conical or a pyramidal shape, wherein the shape marking can be formed as a positive or negative shape, i.e. as an elevation but also as a recess. Several of these different possible shape markings of the same or different kind are possible together.

By such shape markings, which can easily be detected e.g. by an optical or mechanical scanner, the position of the holding device can be identified very precisely.

The second portion preferably comprises a connection portion, which is connected with the first portion. Such a connection portion can also usually be well detected by a scanner and allows the collection of information for a position identification of the holding device. Caused by the fact that the connection portion is connected to the first portion, it is also relatively close to the model of the dental prosthesis part so that it can possibly be scanned by one and the same scanning procedure by which the dental prosthesis part is scanned.

The connection portion also has a preferably simple geometric shape, such as rod-shaped or disk-shaped, since this enables the position identification in a preferred manner. It is especially advantageous if the connection portion projects from a planar surface. This facilitates identification of the connection portion as such for the evaluation of the scan data during position identification.

The holding device also preferably has a holding member by means of which the device can be held in a holder. This holding member is e.g. rod-shaped, so that it can easily be inserted into a respective sleeve of the holder. (The expression “holder” is used for a means that is provided for holding the “holding device”.)

The holding member is preferably formed such that a support of the holding device in a definite position is possible. In a cylindrical, rod-shaped holding member this can for instance be achieved by a flattening of the cylinder at one or several sides.

A device for scanning objects is equipped with a holder in which an above-mentioned device with a definite position orientation can be held and scanned. By such a scanner, jaw models and/or dental models and/or saw tooth model sections or other objects can for instance be scanned for a dental treatment. By using one and the same scanner, a model of a dental prosthesis part, such as the one for an abutment, can also be scanned. The device has a holder for this purpose, which allows a definite (at least a rough) position orientation.

In a method of producing a digital model of a dental prosthesis part, such as an abutment, a dental prosthesis part can first of all be modeled or set onto the holding device. Such a dental prosthesis part can then be scanned together with the holding device. For this purpose, dental prosthesis models and the holding device can be scanned simultaneously and/or successively by one or several scanning procedures. The data of several scanning procedures can be composed by a matching procedure to more comprehensible sets of data. The scanning data can be evaluated to detect on the one hand a portion of the shape of the dental prosthesis model and, on the other hand, the position of the holding device.

The modeling of a dental prosthesis part and/or the scanning procedure can take place at locations other than the location of the evaluation of the scanning data. The latter can take place for instance in a manufacturing center, whereas the modeling and/or scanning can take place at a dental technician and/or a dentist. These steps can also be carried out at a different location.

In a method, a holding device, as described above, can preferably be used. Such a method can also preferably be carried out by means of the device for scanning objects described above.

With such a device it is for instance possible to define the inner shape of the dental prosthesis part by the detected position of the holding device.

In a method of manufacturing a dental prosthesis part, a digital model is first of all generated, as described above, and subsequently the dental prosthesis part is manufactured by the aid of the digital model. Known CAM methods, such as milling, 3D-lithography etc. are possible for this purpose.

A dental prosthesis part manufactured in this way can be composed of ceramics, metal, gold, metal alloy, ceramic alloys, plastics or similar materials.

Preferred embodiments of the invention are now explained by means of the enclosed Figures.

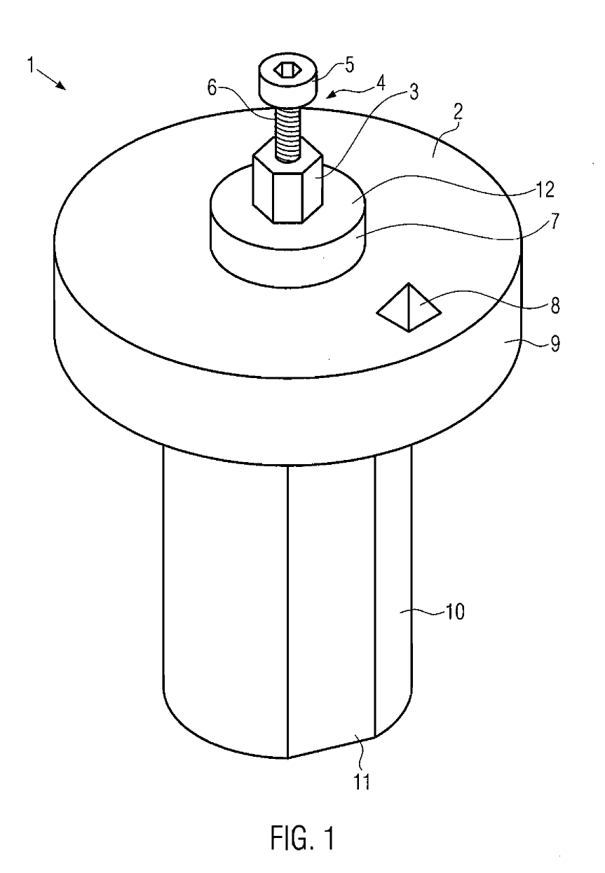

FIG. 1 shows a device for holding a model according to a first embodiment of the invention;

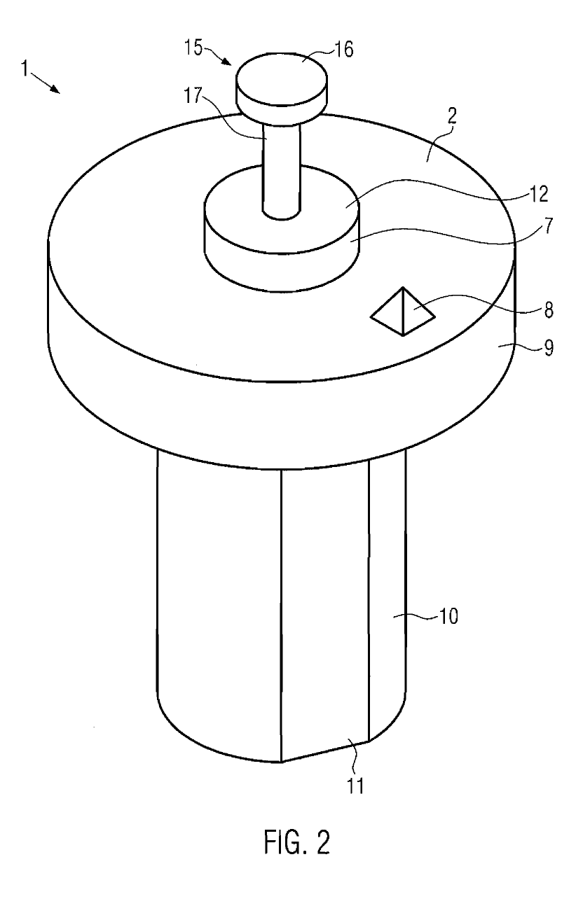

FIG. 2 shows a device for holding a model according to a second embodiment of the invention;

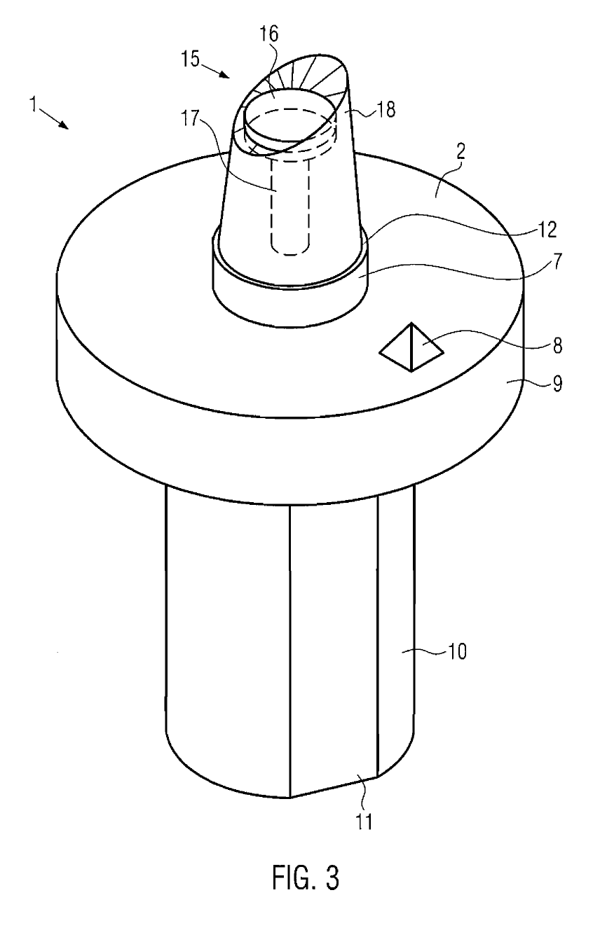

FIG. 3 shows the device of FIG. 2 with a model;

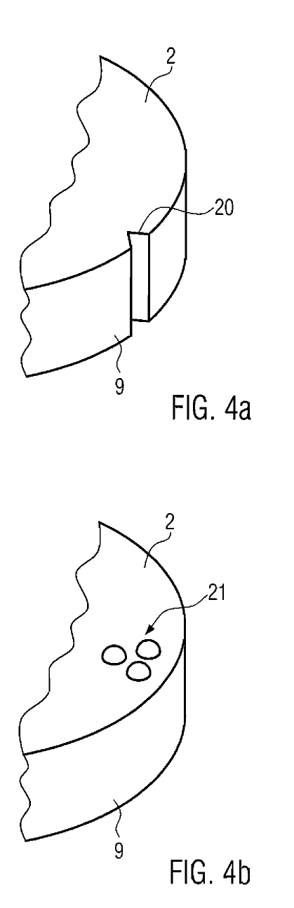

FIG. 4 shows variants of a shape marking;

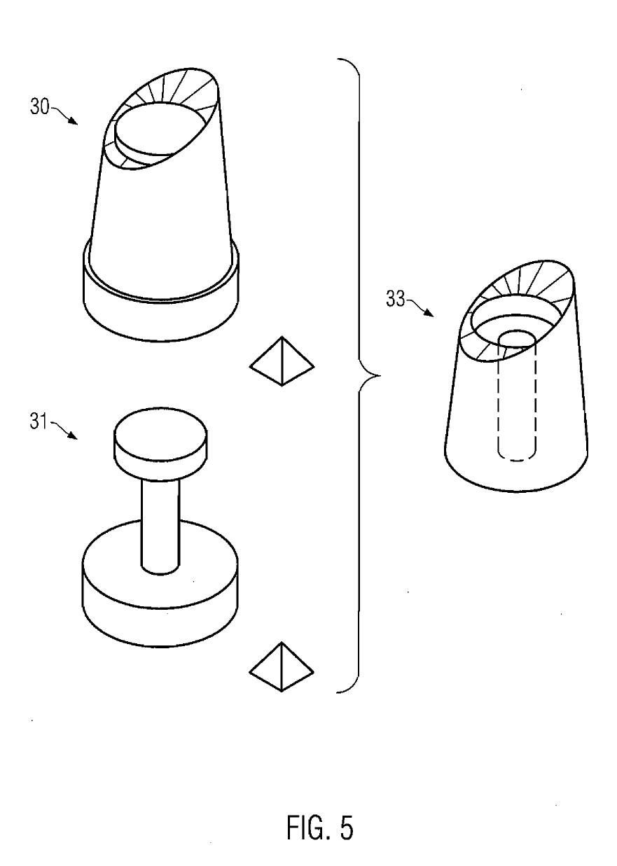

FIG. 5 shows a schematic view of the data for manufacturing a digital model of a dental prosthesis part.

FIG. 1 shows a device 1 for holding a model of a dental prosthesis part. The device 1 comprises a disk-shaped element 9 with a planar surface 2. A connection portion 7, which is disk-shaped in this case with a circular cross section, projects from this planar surface 2. Cross-sectional shapes other than circular are also possible both for the disk 9 and independent thereof for the disk 7, such as a square, rectangular, triangular, hexagonal, polygonal or elliptic cross or other section.

A shape marking in the shape of a rectangular pyramid 8 is shown on the planar surface 2. This shape marking 8 allows a precise position identification of the second portion. The second portion comprises the disk 9 and the disk 7 as well as the shape marking 8. A possible inner shape of an abutment is arranged on the disk 7. This comprises a rod-shaped element 3 with a hexagonal cross-section. Other cross-sectional shapes are also possible, such as square, rectangular, circular, triangular, pentagonal, octagonal or otherwise polygonal or elliptical. The rod-shaped element 3 can fixedly be arranged on the disk 7 and it can for instance be integrally formed therewith. However, it can also be inserted into a respective receptacle in the disk 7.

In the example as shown in FIG. 1, the rod-shaped element 3 has a thread bore into which a screw 4 can be screwed. The screw 4 has a thread 6 with which it is screwed into the thread bore and a head 5, which in this case is a socket screw head. The screw 4 corresponds to such a screw by means of which an abutment can for instance be screwed to an implant.

The illustration of FIG. 1 for the rod-shaped element 3 and the screw 4 are exemplary only. Depending on the desired inner shape of the dental prosthesis part, such as an abutment, any desired shape can exist.

The first portion is provided in this example by the surface 12 of the disk 7, the rod-shaped element 3 and the screw 4.

The device 1 comprises a holding member 10, which in this case is rod-shaped. This member is provided with a flat portion 11 at one side. By this flat portion the device can be held in a defined position.

This defined position can possibly not be precise enough to refer to the inner shape of the model of the dental prosthesis part. Thus, an additional detection of the position by the second portion is advantageous (e.g. by the shape marking 8).

In special examples of a device for holding a model of a dental prosthesis part a definite position identification can be provided by the holding member 10 only.

Caused by an at least roughly definite support, a shape marking 8 is located at a roughly predefined position. Only at this roughly predefined position the shape marking has to be searched for by a scanning procedure and the respective data evaluation, so that this marking cannot only be roughly but precisely defined in position.

The more shape markings are provided the more precise can the position of the holding device be determined.

FIG. 2 shows a variant of the device for holding the model of a dental prosthesis part. It differs from the device of FIG. 1 only in the part that defines the inner shape of a dental prosthesis part. An element 15 is formed with a rod 17 and a head 16 to define the inner shape. This head can either be inserted into a disk 7 or it can be formed integrally therewith or it may be attached in a different manner to the disk (e.g. it can be screwed in). The variant in FIG. 2 is also exemplary only.

It must be noted that the inner shape of the dental prosthesis part does not have to be predefined by the holding device, since this dental prosthesis part can be inserted digitally later when generating a model of digital data. To provide the modeler with a better survey over the later structure of the dental prosthesis part, it is advantageous if the holder already has the inner shape of the dental prosthesis part. This is for instance advantageous for estimating wall thickness in the model.

On the other hand, it is sufficient if the holding device defines the inner shape approximately only. Deviations in some dimensions of 5% or 10% can be provided, e.g. to make a channel for the thread 6 of the screw 4 broader than the thread 6 itself.

Irrespective of whether the device defines the inner shape of the dental prosthesis part or not, the device has a first portion in which the model can be modeled on. If for instance the element 15 with the rod 17 and the head 16 is missing in FIG. 2, the first portion is provided by the surface 12 of the disk 7.

In FIG. 3 the holder of FIG. 2 is shown with a dental prosthesis part modeled on. The model 18 of the dental prosthesis part is for instance modeled with wax on the surface 12 around the element 15.

In FIG. 4a a variant of the holding device is shown, in which a notch 20 is provided in the disk 9 on the side, by means of which a clear position identification of the holding device is also enabled.

FIG. 4b shows a further example in which three hemispherical elements 21 are provided on the surface 2 of the disk 9.

A holding device with a model of a dental prosthesis part 18, as it is shown in FIG. 3, can be scanned by a scanning device.

Dental scanners for such procedures are known. By using such a dental scanner, the outer shape of the model 18, the exposed surface of the head 16 and of the surface 12 can be scanned. Thereby the outer shape of the dental prosthesis part can be determined. Furthermore, the scanner can detect the surface 2 and the shape marking 8. The edges that are defined by the disk 7 and the disk 7 itself can also be scanned. A respective set of data obtained is shown exemplarily in FIG. 5 with reference numeral 30.

In a method of manufacturing a digital model of a dental prosthesis part, a set of data further exists, which represents the desired inner shape of a dental prosthesis part. A respective set of data is shown in FIG. 5 by reference numeral 31. The relation of this set of data to a shape marking is known and also memorized (see FIG. 5).

The set of data 31 shown in FIG. 5 represents the actually desired inner shape of the dental prosthesis part, whereas the form pieces in FIGS. 1, 2 and 3 are only an orientation aid for the manufacture of the model. The set of data 31, which basically corresponds to the shape of the holding device of FIG. 2, can have a somewhat larger diameter to enable for instance some tolerance for the insertion of a screw or the like.

It must be noted that the set of data 31 used for producing a digital model, does not inevitably have to correspond exactly to the shape provided in the holding device 1, although this is, of course, possible.

The data 30 and 31 in FIG. 5 can be combined with a respective (software) method to subsequently obtain a digital model 33 of a dental prosthesis part. For this purpose, the most different methods can be used. The relative arrangement of the set of data 30 and 31 can for instance be determined by means of the definite position identification of the holder, and subsequently the model 33 can be obtained by “subtraction” of the two sets of data. The model 33 has an abutment in which a central opening for a screw thread and space for the head of a screw is provided. Such a digital model 33 can be supplied to a known CAM method, such as a milling method, 3D-lithography or the like to manufacture a dental prosthesis part.

The invention further refers to a computer-readable data carrier with instructions for carrying out one of the methods described above as soon as the respective instructions are loaded onto a computer.

1. Device for holding a model of a dental prosthesis part, comprising:
a first portion in which the model of the dental prosthesis part can be modeled on, and
a second portion which allows a definite position identification of the holder.

2. Device as claimed in claim 1, wherein the first portion corresponds to the inner shape of the dental prosthesis part or that the first portion is formed for receiving a model piece into or onto which a model piece having the inner shape of the dental prosthesis part can be set in or on.

3. Device as claimed in claim 1 wherein the second portion comprises at least one planar surface.

4. Device as claimed in claim 1, wherein the second portion comprises at least one shape marking, such as a groove, a bead, a projection, a recess, an elevation, a sphere, a hemisphere, a positive or negative conical or pyramidal shape.

5. Device as claimed in claim 1, wherein the second portion comprises a connection portion that is connected to the first portion.

6. Device as claimed in claim 5, wherein the connection portion is rod or disk-shaped and projects from a planar surface.

7. Device as claimed in claim 1, wherein the device further comprises a holding member by means of which the holding device can be held in a holder.

8. Device as claimed in claim 7, wherein the holding member is rod-shaped.

9. Device as claimed in claim 7 wherein the holding member is formed such that a support of the device in a definite position is possible.

10. Device for scanning objects, such as jaw models, and/or dental models and/or saw tooth model sections, comprising a holder in which a device as claimed in claim 1 with a definite position orientation can be held and scanned.

11. Method for generating a digital model of a dental prosthesis part, comprising the steps:
evaluating scan data for detecting at least one portion of the shape of a dental prosthesis model, and
evaluating the scan data for detecting at least the position of a device for holding the dental prosthesis part.

12. Method as claimed in claim 11, characterized by the step of scanning the dental prosthesis part and the holding device.

13. Method as claimed in claim 11, characterized by the step of modeling the dental prosthesis model on the holding device.

14. Method as claimed in claim 11, wherein the holding device is provided by a device as claimed in claim 1.

15. Method as claimed in claim 11, wherein the detected position of the holding device is evaluated to define the inner shape of the dental prosthesis part.

16. Method for manufacturing a dental prosthesis part, comprising the following steps:
generating a digital model as claimed in claim 11;
manufacturing a dental prosthesis part with a digital model, comprising a CAM method such as milling, or 3D-lithography.

17. Computer-readable medium with instructions for a computer to carry out the method as claimed in claim 11.
